(19) United States
(12) Patent Application Publication
(10) Pub. No.: US 2007/0277350 A1
(43) Pub. Date: Dec. 6, 2007

(54) Leveling caster system and method of using same

(76) Inventor: Stephen Hines, Glendale, CA (US)

Correspondence Address: Wagner, Anderson & Bright, LLP, 3541 Ocean View Blvd., Glendale, CA, 91208, US

(21) Appl. No.: 11/447,566

(22) Filed: Jun. 5, 2006

(51) Int. Cl. B60B 33/00

(52) U.S. Cl. 16/35 R

(57) ABSTRACT

A caster assembly and the method of using same that uniquely combines a leveling foot mechanism with a specially designed caster that can be interconnected with a structure such as a cabinet or the like that is adapted to be rollably supported on a supporting surface. The leveling foot mechanism includes a threaded bolt that passes through the vertical axis of the caster. When the caster is interconnected with a cabinet, the upper end of the threaded bolt of the leveling foot mechanism extends through the floor panel of the cabinet so that it can be adjusted from the interior of the cabinet in a manner to take the weight off of the wheel and enable the cabinet to be leveled relative to the supporting surface.

### BACKGROUND OF THE INVENTION

1. Field of the Invention

The present invention relates generally to casters and caster systems. More particularly the invention concerns a caster system for use in connection with cabinets and the like that functions to disengage the caster wheel from the supporting surface, to level the cabinet and to act as a brake to prevent accidental rolling of the cabinet.

2. Description of the Related Art

Casters are well known in the art and are widely used for a variety of purposes. Prior art casters are typically of two types, either a rigid caster or a swivel caster. A rigid caster is primarily utilized for straight-line travel, meaning rolling forward or backward. A swivel caster, on the other hand, is capable of rotating 360°. In either case, the caster construction comprises a wheel that is rotatably mounted within a frame. The frame of the caster is often called a caster bracket or fork. A mounting plate is generally provided on the top of the conventional swivel caster and is connected to a swivel bearing. As a general rule the mounting plate is provided with a plurality of holes that are used to bolt the caster to the object it supports.

Casters are widely used to rollably support structures such as furniture, cabinets, retail store and tradeshow fixtures, movie sets, material handling trucks and the like. Casters permit the structure to which they are attached to be easily rolled into a selected position. When in position, the structure frequently needs to be leveled and secured in place. Preferably, both the casters and the leveling mechanism are disposed proximate the corners of the structure which they support are readily accessible and ideally occupy a minimum amount of space.

U.S. Pat. No. 6,871,379 issued to Ebeling, et al, is exemplary of one type of prior art leveling caster. More particularly, Ebeling, et al, discloses a method and apparatus for appliance installation and leveling using a leveling caster. The leveling caster includes a top shelf connected to wheels by a scissors-type structure. The height of the scissors-type structure can be adjusted using an adjustment bolt from the front of the appliance without requiring access to the rear of the appliance. The leveling caster is adjustable over a wide range of heights, is strong enough to bear heavy appliances, and allows height adjustment while minimizing incidental horizontal motion.

Another prior art patent dealing with leveling casters is U.S. Pat. No. 6,892,784 issued to Mass. The Mass patent concerns a portable room divider having a plurality of wall panels interconnected by hinges. Feet project laterally from both sides of some of the wall panels and self-leveling casters are mounted to the feet. A spring biasing mechanism forces each caster against the floor to compensate for irregularities in the floor surface. Thus, the self-leveling casters are maintained against the floor to further stabilize the room divider when in use. A mechanism is provided to connect and join together multiple room dividers in a series.

As will be better understood from the discussion which follows, the construction of the novel caster assemblies of the present invention uniquely combines a leveling foot mechanism with a specially designed caster. The leveling foot mechanism of one form of the invention includes a threaded bolt that passes through the vertical axis of the caster. The threaded bolt, which has a leveling foot connected to its lower extremity, is threadably received within a threaded stem that is connected to the top plate of the caster assembly and extends through the floor panel of the cabinet to which the caster assembly is affixed. After the structure to which the caster assembly is affixed is rolled into position, the bolt can be threaded down within the stem in a manner to take the weight off the caster wheel and enable the structure to be precisely leveled.

### SUMMARY OF THE INVENTION

It is an object of the present invention to provide a novel caster assembly and the method of using same that uniquely combines a leveling foot mechanism with a specially designed caster that can be interconnected with a structure such as a cabinet or the like that is adapted to be rollably supported on a supporting surface.

Another object of the invention is to provide a novel caster assembly of the aforementioned character in which the leveling foot mechanism includes a threaded bolt that passes through the vertical axis of the caster. When the caster is attached to a cabinet, the upper end of the threaded bolt of the leveling foot mechanism extends upwardly through a hole in the floor panel of the cabinet so that the bolt can be rotated from the interior of the cabinet in a manner to take the weight off of the caster assembly and enable the cabinet to be leveled relative to the supporting surface.

Another object of the invention is to provide a novel caster assembly as described in the preceding paragraphs which is of a simple construction and can be readily attached to cabinets and like structures to enable the structures to be easily rolled from place to place. After the structure is rolled into the desired position, the leveling foot mechanism of the caster assembly can be easily manipulated from the interior of the cabinet using conventional tools.

Another object of the invention is to provide a caster assembly of the character described that is highly reliable and operation and can be inexpensively manufactured in quantity.

### BRIEF DESCRIPTION OF THE DRAWINGS

FIG. 1 is a generally perspective view of one form of the caster assembly of the present invention.

FIG. 2 is a side elevational view of the caster assembly illustrated in FIG. 1 showing the leveling mechanism of the apparatus interconnected with a structure such as a cabinet and having been manipulated in a manner to take the weight off the caster wheel.

FIG. 3 is a front view of the caster assembly illustrated in FIG. 1 showing the caster wheel in engagement with the floor panel of the structure to which the caster assembly is interconnected.

FIG. 4 is a longitudinal cross-sectional view of the caster assembly shown in FIG. 2.

### DESCRIPTION OF THE INVENTION

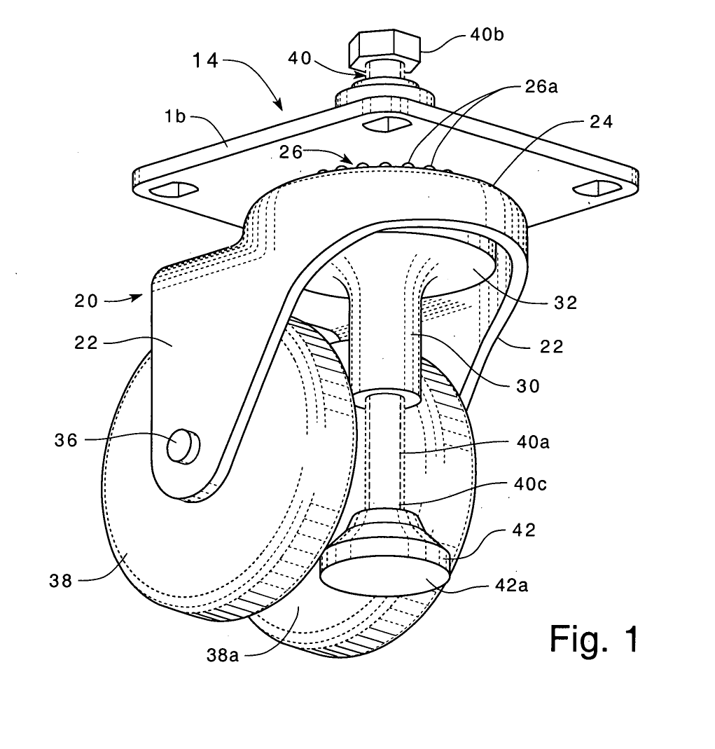

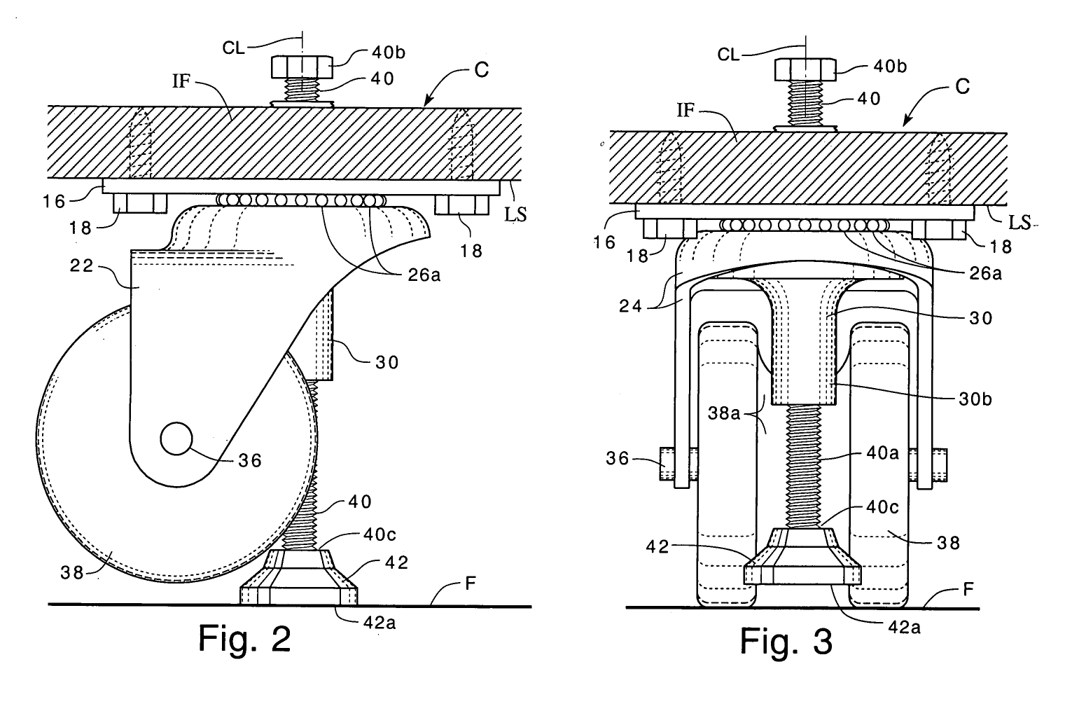

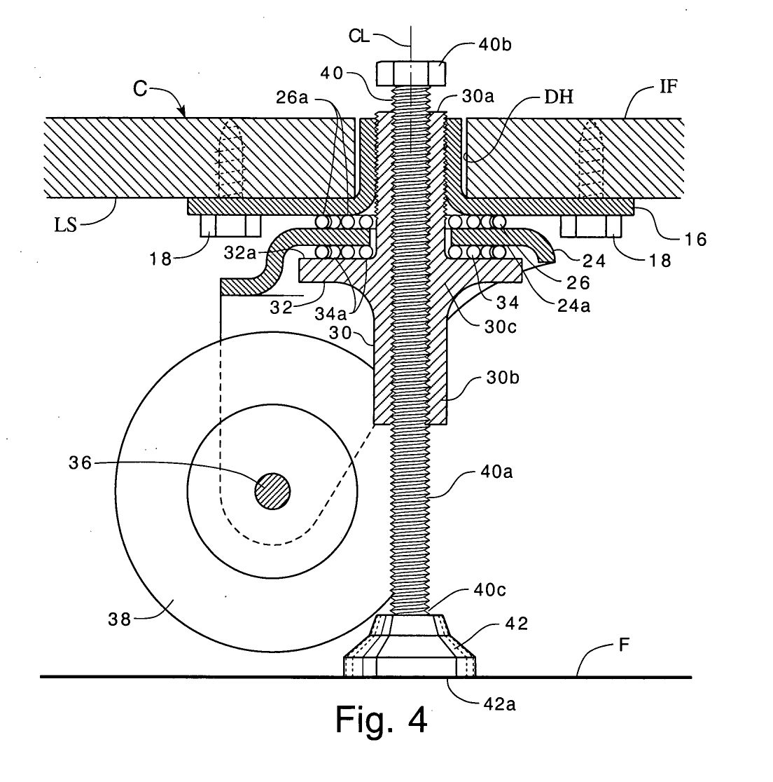

Referring to the drawings and particularly to FIGS. 1 and 3, one form of the caster assembly of the present invention is there illustrated and generally designated by the numeral 14. In this form of the invention the caster assembly comprises a mounting plate 16 that is connected to the lower surface “LS” of the internal floor member “IF” of a cabinet structure “C” by means of a plurality of connectors, such as screws 18. Connected to mounting plate 16 for rotation with respect thereto is a caster frame 20, which comprises a pair of spaced-apart side arms 22 that are integrally formed with a frame base portion 24 (see FIG. 4). As best seen in FIG. 2, a first swivel bearing 26, which comprises a plurality of circumferentially spaced ball bearings 26a, is disposed between base portion 24 and a mounting plate 16 to permit free rotation of frame 20 with respect to mounting plate 16.

Forming an important aspect of the apparatus of the present invention is an internally threaded, generally vertically extending stem member 30, which is operably interconnected with mounting plate 16 (FIG. 4). More particularly, as illustrated in FIG. 4, stem member 30, which has an axial centerline “CL”, comprises a neck portion 30a, a lower barrel portion 30b and an intermediate portion 30c. As illustrated in FIGS. 1 and 4, intermediate portion 30c comprises a flange portion 32 having an upper surface 32a. Disposed between the upper surface 32a and the lower surface 24a of frame base portion 24 is a second swivel bearing 34, which comprises a plurality of circumferentially spaced ball bearings 34a. As indicated in FIG. 4, mounting plate 16 has a center line “CL” with which the stem member 30 and threaded bolt 40 are aligned.

Rotatably supported by an axle 36 that extends between and is supported by side arms 22 of the caster frame is a centrally grooved wheel or roller 38. As illustrated in FIG. 3, the barrel portion 30b of stem 30 is disposed rearwardly of wheel 38 and extends downwardly within the groove 38a of the caster wheel.

Threadably interconnected with internally threaded stem member 30 is an externally threaded bolt 40. Bolt 40 has an externally threaded shank portion 40a having a wrench-engaging head portion 40b and a lower portion 40c. Connected to lower portion 40c is a leveling foot 42, which is provided with a substantially planar lower surface 42a. As best seen in FIG. 4, bolt 40 extends through internally threaded stem member 30 and is rotatably movable therewith between a first elevated position shown in FIG. 3 and a second lowered position shown in FIG. 2 wherein surface 42a of the leveling foot 42 is in engagement with the supporting surface or floor “F” which supports the cabinet structure.

In carrying out the method of the invention for leveling the cabinet relative to a supporting surface, through use of a plurality of caster assemblies 14, the first step in one form of the method of the invention comprises the step of drilling a plurality of holes through the internal floor “IF” of the cabinet to form a plurality of drilled holes “DH” (FIG. 4) that are slightly larger than the neck portion 30a of the threaded stem 30. This done, from beneath the cabinet, the neck portions 30a of the threaded stems of each of the plurality of caster assemblies 14 are inserted through a selected drilled hole. Next, the mounting plate 16 of each of the caster assemblies is interconnected with the cabinet floor using the threaded connectors 18. With the mounting plate connected to the floor of the cabinet, a portion of the neck 30a of the stem 30, as well as a portion of the bolt 40 including the head portion 40b, extends through the floor of the cabinet in the manner shown in FIG. 3 of the drawings. To complete the leveling step and operating from the interior of the cabinet, each of the threaded bolts of each of the caster assemblies is controllably rotated in a manner to move each of the threaded bolts of the plurality of caster assemblies into the lowered position shown in FIG. 2 and in engagement with the supporting surface “F”. By selectively rotating the threaded bolts of the various caster assemblies a cabinet can be precisely leveled.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A caster assembly for interconnection with a structure having a floor member, said caster assembly comprising:
(a) a mounting plate connected to the floor member of the structure;
(b) a caster frame connected to said a mounting plate;
(c) a wheel rotatably connected to said caster frame;
(d) a generally vertically extending threaded stem connected to said mounting plate, said threaded stem having first and second ends; and
(e) a threaded bolt extending through and threadably interconnected with said threaded stem for movement between a first position and a second position, said threaded bolt having first and second ends.

2. The caster assembly as defined in claim 1, further including a leveling foot connected to said second end of said threaded bolt.

3. The caster assembly as defined in claim 1 in which said first end of said generally vertically extended threaded stem extends through the floor member of the structure.

4. The caster assembly as defined in claim 1, further including a swivel bearing disposed intermediate said caster frame and said mounting plate.

5. The caster assembly as defined in claim 1 in which said wheel is provided with a central groove and in which said threaded stem extends through said central groove.

6. The caster assembly as defined in claim 1 in which said mounting plate has a center line and in which said threaded stem is axially aligned with said center line.

7. A caster assembly for interconnection with a structure supported on a supporting surface, said structure having an internal floor member, said caster assembly comprising:
(a) a mounting plate connected to the internal floor member of the structure;
(b) a caster frame rotatably connected to said a mounting plate for rotation with respect thereto;
(c) a centrally grooved wheel rotatably connected to said caster frame;
(d) a generally vertically extending, internally threaded stem connected to said mounting plate, said threaded stem having an axial centerline, a neck portion, a barrel portion and an intermediate portion, said barrel portion extending through said groove in said grooved wheel and said neck portion extending through the floor of said structure; and
(e) an externally threaded bolt extending through and threadably interconnected with said threaded stem for movement between a first elevated position and a second lowered position in the engagement with the supporting surface.

8. The caster assembly as defined in claim 7, further including a leveling foot connected to said threaded bolt for engagement with the supporting surface when said threaded bolt is in said second lowered position.

9. The caster assembly as defined in claim 7, further including a first swivel bearing disposed intermediate said caster frame and said mounting plate.

10. The caster assembly as defined in claim 7 in which said intermediate portion of said threaded stem is provided with a flange portion and in which said caster assembly further includes a second swivel bearing disposed between said flange portion and said caster frame.

11. The caster assembly as defined in claim 7 in which said mounting plate has a center line and in which said axial centerline of said threaded stem is aligned with said center line.

12. A method for leveling a cabinet relative to a supporting surface, through use of a plurality of caster assemblies, the cabinet having a floor and an interior space and each of the caster assembly comprising a mounting plate; a caster frame rotatably connected to the mounting plate for rotation with respect thereto; a grooved wheel rotatably connected to the caster frame; a generally vertically extending threaded stem connected to the mounting plate, the stem having an axial centerline, a neck portion, a barrel portion and an intermediate portion; and a threaded bolt extending through and threadably interconnected with said threaded stem for movement between a first elevated position and a second lowered position, the threaded bolt having first and second ends; said method comprising the steps of:
(a) drilling a plurality of holes through the floor of the cabinet to form a plurality of drilled hole larger than the neck portion of the threaded stem;
(b) from beneath the cabinet, inserting the neck portion of the threaded stem of each of the plurality of caster assemblies through a selected drilled hole;
(c) interconnecting the mounting plate of each of the caster assemblies with the floor of the cabinet; and
(d) from the interior of the cabinet, rotating the threaded bolt of each of the caster assemblies in a manner to move each of the threaded bolts of the plurality of caster assemblies into the lowered position and in engagement with the supporting surface.
